(19) United States
(12) Patent Application Publication
(10) Pub. No.: US 2012/0297650 A1
(43) Pub. Date: Nov. 29, 2012

(54) GREETINGS CARD

(76) Inventor: Richard Burley, Maidenhead (GB)

(21) Appl. No.: 13/261,379

(22) PCT Filed: Jan. 27, 2011
(86) PCT No.: PCT/GB11/00109

§ 371 Date: Jul. 23, 2012

(30) Foreign Application Priority Data
Jan. 27, 2010 (GB) 1001313.4
Jun. 22, 2010 (GB) 1010485.9

(51) Int. Cl. G09F 1/00; B32B 37/12

(52) U.S. Cl. 40/124.01; 156/60

(57) ABSTRACT

The present invention relates to greetings cards. The present invention relates in particular to methods of addressing the apparent short-term nature of cards. Many card are simply placed in a trash basket after use. This represents a tremendous waste; further whilst it is sometimes desired to retain a card, the card is generally manufactured to a cost which means that one is less likely to want to retain such a card. The present invention seeks to provide a solution to the problems addressed above. The present invention seeks to provide a greetings card (14) which is both simple and convenient to retain. The card comprises an adhesive member (35,36,37) allowing it to be re-used and thereby provides an economical product in terms of cost and for the environment.

### FIELD OF INVENTION

The present invention relates to a greetings card. The present invention relates to, in particular, a greetings card which overcomes an apparent short-term nature of cards.

### BACKGROUND TO THE INVENTION

A greetings card generally comprises an illustrated, folded card featuring an expression of friendship or other sentiment. Although greetings cards are usually given on special occasions, such as birthdays, Christmas, or other holidays, they are also sent to convey thanks or express other feelings; indeed, for the purposes of this disclosure, cards will also be taken to include invitations, cards of condolence etc. Greetings cards, usually packaged with an envelope, come in a variety of styles. There are both mass-produced as well as handmade versions that are distributed by hundreds of companies large and small. Whilst typically inexpensive, more elaborate cards with die-cut features or glued-on decorations may cost up to GB £5 each, or more.

In the United Kingdom it is presently estimated that nearly two billion pounds sterling are spent on greetings cards every year, with the average person sending 55 cards per year. In western societies and increasingly in other societies, many people traditionally mail seasonally themed cards to their friends and relatives in December at or around Christmas time. Many service businesses also send cards to their customers in this season, usually with a Christmas message or what is deemed by some to be a universally acceptable non-religious message such as “happy holidays” or “seasons' greetings”.

Irrespective of the event, greetings cards can be effective tools to communicate important feelings to people that other individuals or families care about: The custom of sending greetings cards can be traced back to the ancient Chinese, who exchanged messages of goodwill to celebrate the New Year; the early Egyptians conveyed their greetings on papyrus scrolls. By the early 1400s, handmade paper greetings cards were being exchanged in Europe. The Germans are known to have printed New Year's greetings from woodcuts as early as 1400, and handmade paper Valentines were being exchanged in various parts of Europe in the early to mid-1400s.

By the 1850s, the greetings card had been transformed from a relatively expensive, handmade and hand-delivered gift to a popular and affordable means of personal communication, due largely to advances in printing and mechanization. This was followed by new trends like Christmas cards, the first of which appeared in published form in London in 1843 when Sir Henry Cole hired artist John C Horsley to design a holiday card that he could send to his friends and acquaintances. In the 1860s, companies like Charles Bennett began the mass production of greetings cards. Well known artists were employed as illustrators and card designers.

Technical developments like colour lithography in 1930 propelled the manufactured greetings card industry forward. This has resulted in a reduction in the cost of cards, but a trend has developed such that once a card has been displayed for a period of time—for example two weeks or so—then the card is either disposed of or filed as a keepsake—especially in the case of the exchange of cards by lovers or, for example, a wedding album, when cards are retained along with photographs and other mementoes. As a direct result, the quality of a card is typically not particularly good; cards are made to a price and a typical card is disposed of within a relatively shot period of time. Additionally, since so many cards celebrate an event, once a period of time after the event has expired; then the card is disposed, typically irrespective of the quality of the card.

Notwithstanding the above, some people will wish to retain a card because of the message upon the card—importance of an event, for example, or fondness of the person who sent the message. If left upon a mantelpiece or similar surface, the front picture might lose its date significance, get damaged, fade because of being in an exposed position, with the result that the message associated with a once pristine card is disposed of because of the picture is no longer presentable. Indeed, like a multi-use corporate envelope, the message may remain within the envelope but its exterior will become shabby and not pleasant to look at.

In another scenario, a person is a member of an online social networking group such as Face-book™ and the person may become friendly on-line with another person, group or the like and may download a picture of said other person, group or common interest. The Face-book user may swap friends and may wish to replace one picture with another. However, traditional picture frames are not quite appropriate by way of form nor do they necessarily easily allow a simple exchange of pictures.

In a still further scenario, a person, family, group or the like may be photographed before a particular site—e.g. a well-known location such as Nelson's Column etc.—a photograph is produced, inserted in a frame or merely forgotten after being placed in a photo-album/left as an entry on a memory card associated with a camera. Despite the recorded image, there exists no memento or other tangible memory of the event.

### OBJECT OF THE INVENTION

The present invention seeks to provide a solution to the problems addressed above. The present invention seeks to provide a greetings card or memento which is both simple and convenient to retain and display.

### STATEMENT OF INVENTION

In accordance with a first aspect of the invention, there is provided a greetings card comprising a support member having an inside face suitable for adding a greeting, an adhesive member, the adhesive member comprising a first layer of adhesive, a carrier layer and a second layer of adhesive wherein the card and the adhesive member are adapted to engage with a picture to provide a card having a pictorial representation and; wherein the pictorial representation is adhesively secured to the carrier member by the second layer of adhesive and the carrier member is adhesively secured to the support member by the first layer of adhesive; wherein in a first mode the card is operable to provide a greetings card and, in a second mode, one of the support member or pictorial representation, when respectively separated from the pictorial representation or support member, can be adhesively secured to an object. In the alternative the card is reused and the message and or artwork is changed. The support member is conveniently made from cardboard, but other materials may also be used.

Thus, once a card has time-expired, the pictorial representation, being a photograph, piece of artwork (being two- or three-dimensional), water colour etc maybe utilised again and be mounted—using its own adhesive or mounting means upon a further surface, being one of a substantially non-dusty surface. Indeed, further advantages of the invention include the fact that the cards can be more easily personalized and a greater choice can be provided to the consumer. Not only can the cards comprise birthday cards, greetings cards, Christmas cards and the like, they may also comprise memento cards etc. A mount with adhesive tape applied thereto can be either attached to a host card or supplied separately, the mount can be card, plastic, magnetic sheet or other suitable materials. The mount will be used when the pictorial representation comprises a fragile material or thin paper, using a mount makes it easier to detach from host card and avoids curving. Rather than the pictorial representation being removed, the card could be re-used with a different greeting placed in the card—that is to say the greeting, written or printed upon a piece of paper, is exchanged for a new greeting written or printed upon a second piece of paper by a second person. In another scenario a card with a first pictorial representation with a first greeting is sent by postal mail to a recipient, for their birthday. For a subsequent event an email with a picture may be sent with a new greeting—or merely just a new greeting, which is then printed off local to the recipient and one of or both the picture a and message is changed. It may be that the person sending the e-mail may wish to donate an amount of cash to charity, in recognition of resources not being wasted. Conveniently, for example, a charity would have a website whereby a new image is selected and purchased/ a donation given.

In the alternative, upon time expiry of the occasion celebrated, the card support may be preferentially retained, by reason, for example, it carries a message of accolade, encouragement, or of sorrow and attached to an object, as a keepsake etc.

The first adhesive can conveniently comprise a pressure sensitive adhesive; once released from the support card, the picture can be adhesively secured to an object. The pictorial representation can comprises one of a photograph, a painting, a three-dimensional collage or other form of two or three-dimensional artwork. The greetings card can comprise a generally rectangular shape. The first and second adhesives may comprise a releasable, low tack adhesive.

There can be first and second types of adhesive, wherein a first adhesive is a releasable, low tack adhesive and the second adhesive is a stronger, more permanent adhesive. Conveniently, the low tack adhesive is an aqueous acrylic adhesive. Once the pictorial representation has been attached to the adhesive sandwich, the releasable adhesive is retained by the pictorial representation; upon removal of the pictorial representation from the support card. Other types of, preferably releasable, adhesive may be employed. Two or more different types of adhesive may be applied to the rear of the picture card. A plastics film may be applied to the pressure sensitive adhesive applied to the rear of the picture. Further adhesives that are washable in water may also be utilised. A polymeric magnetic sheet element may be used additionally, whereby to assist in attachment to ferromagnetic objects.

The card conveniently comprises a generally rectangular shape, but the invention is not limited to such a shape. The shape and size of a card are not limited to any particular dimensions.

In accordance with another aspect of the invention, there is provided a greetings card comprising a support member having an inside face, an adhesive member, the adhesive member comprising a layer of reusable adhesive, wherein the card and the adhesive member are adapted to adhesively retain a first pictorial representation wherein in a first mode is operable to provide a greetings card with a first pictorial representation and in a second mode is operable to provide a backing member with adhesive to enable a second or further representation to be attached to the card. The inside face may carry a personalised greeting. Additionally, or in the alternative, the greeting may be secret and be placed on the first leaf, positioned underneath a picture or on an underside of a picture.

Thus, once a card has time-expired, the pictorial representation, being a photograph, piece of artwork (being two- or three-dimensional), water colour etc maybe disposed of and the card be retained for supporting another picture. Indeed, further advantages of the invention include the fact that the cards can be more easily personalized and a greater choice can be provided to the consumer. Not only can the cards comprise birthday cards, greetings cards, Christmas cards and the like, they may also comprise memento cards etc.

The adhesive can conveniently comprise a pressure sensitive adhesive; once a picture has been removed from the support card, a further picture can be secured to the card. The pictorial representation can comprises one of a photograph, a painting, a three-dimensional collage or other form of two- or three-dimensional artwork.

In accordance with a further aspect of the invention, there is provided a greetings card component operable as above, the component comprising a support member having an inside face suitable for adding a greeting, an adhesive member, the adhesive member comprising a first layer of reusable adhesive, a carrier layer and a second, permanent, adhesive layer wherein the card and the adhesive member are adapted to engage with a pictorial representation; wherein there is provided a film of material operable to protect the permanent adhesive member prior to presentation of a pictorial representation to the adhesive.

In accordance with a still further aspect of the invention, there is provided an adhesive member for a greetings card operable as above, comprising a first layer of reusable adhesive, a carrier layer and a second, permanent adhesive layer. Conveniently, the adhesive member comprises a homogeneous layer applied to the pictorial representation or mount therefor and preferentially attaches itself to the pictorial representation or mount yet enables re-application to a number of other surfaces.

In accordance with a further aspect of the invention, there is provided a method of making a greetings card in accordance with the invention, said method comprising the steps of: selecting an image; selecting a support card; and, attaching the image to the support card using an adhesive member comprising a support sheet with first and second adhesive layers on first and second sides of the support sheet. The adhesive member may come supplied with removable release sheets; the adhesive sheet member may already be attached to one of a support card or an image.

It would be possible to order the products form a website and have the components delivered to an address for completion or may be formed together after placement of an order and sent to a third party at a third party address.

### BRIEF DESCRIPTION OF THE FIGURES

For a better understanding of the present invention, reference will now be made, by way of example only, to the Figures as shown in the accompanying drawing sheets, wherein:—

FIG. 1 is a perspective view of cards as are typically placed upon a shelf within a house;

FIGS. 2 a-c show how a single card is fabricated;

FIGS. 3a-3f show a various embodiments of the invention;

FIG. 4a, b show a perspective view of a first card in accordance with another aspect of the invention;

FIGS. 5 a-c show how a the invention can perform as an invitation card; and,

FIGS. 6a-c show a further embodiment of the invention;

FIGS. 7a and 7b show specific uses of the invention;

FIGS. 8a and 8b show further variations of the invention;

FIG. 9 shows a prior art card display unit; and,

FIG. 10 shows a point of sale arrangement.

### DETAILED DESCRIPTION OF THE PREFERRED EMBODIMENTS

There will now be described, by way of example only, the best mode contemplated by the inventor for carrying out the present invention. In the following description, numerous specific details are set out in order to provide a complete understanding to the present invention. It will be apparent to those skilled in the art, that the present invention may be put into practice with variations of the specific.

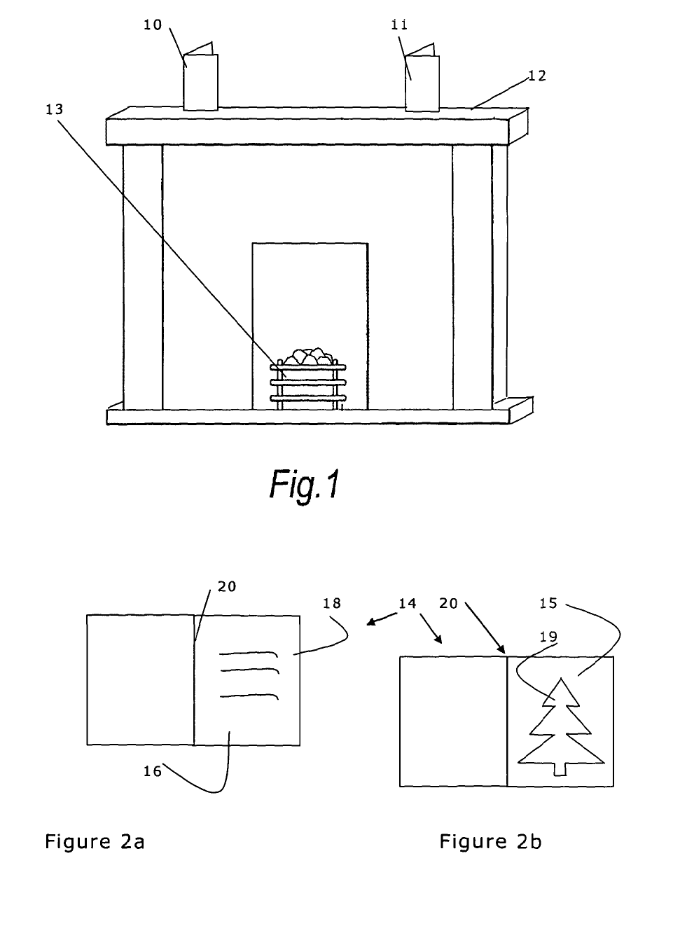

Referring now to FIG. 1, there is shown, a typical setting for a greetings card, where such cards 10, 11 are situated upon the mantelpiece 12 of a fireplace 13. The cards, as described above may be greetings cards in general, such as a thank you note, a birthday greetings card, a Christmas card etc. The cards typically comprise a piece of card of a weight, for example, of 200 g per square metre; thicker or thinner cards may be employed; dependent, amongst many other aspects such as the size of the card and the need to bear any further decorations such as badges (for example, a badge may also be attached to a birthday card for a young child stating e.g. “I am six today”), glitter etc, and, of course, the price.

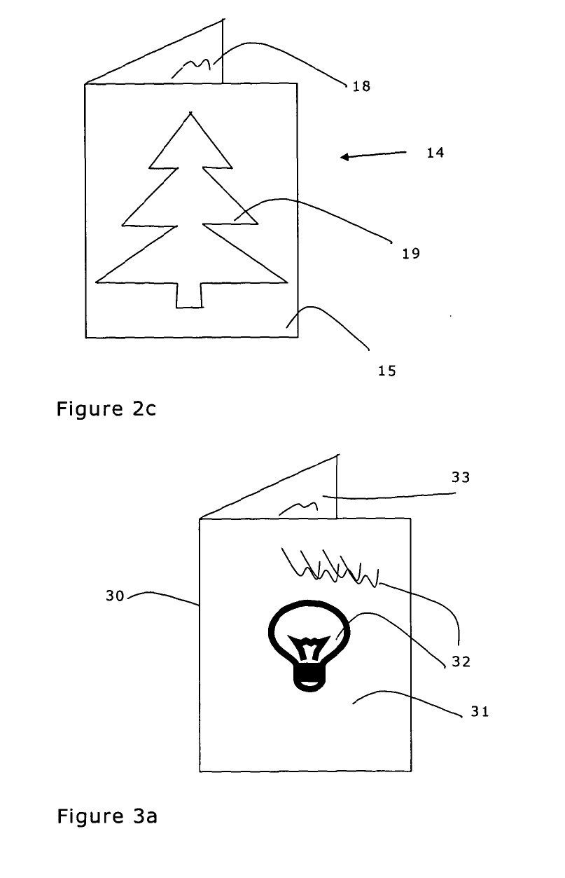

FIGS. 2a, 2b and 2c show how a simple card is made from a single sheet of card. FIG. 2a details the inside surface 16 of a card 14; to the left of a fold line 20 there may be ornamentation 18 or it may be blank; on the right hand side, there will typically (but not necessarily) be a printed message—the sender of the card can sign adjacent the message or create and sign his own personalised greeting. FIG. 2b shows the outside cover 15 of card 14; the pictorial representation 19 and any message (not shown) are placed to the right of a fold line 20; there may be manufacturer's markings (not shown) on the left hand side of the fold line. FIG. 2c shows how the card, once folded, can be placed upon a suitable generally horizontal surface.

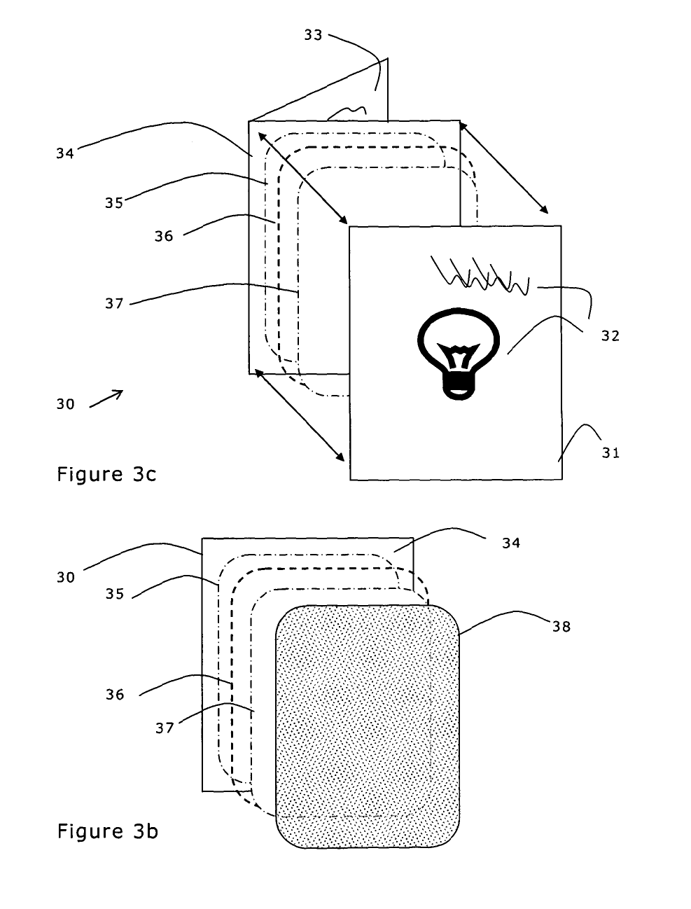

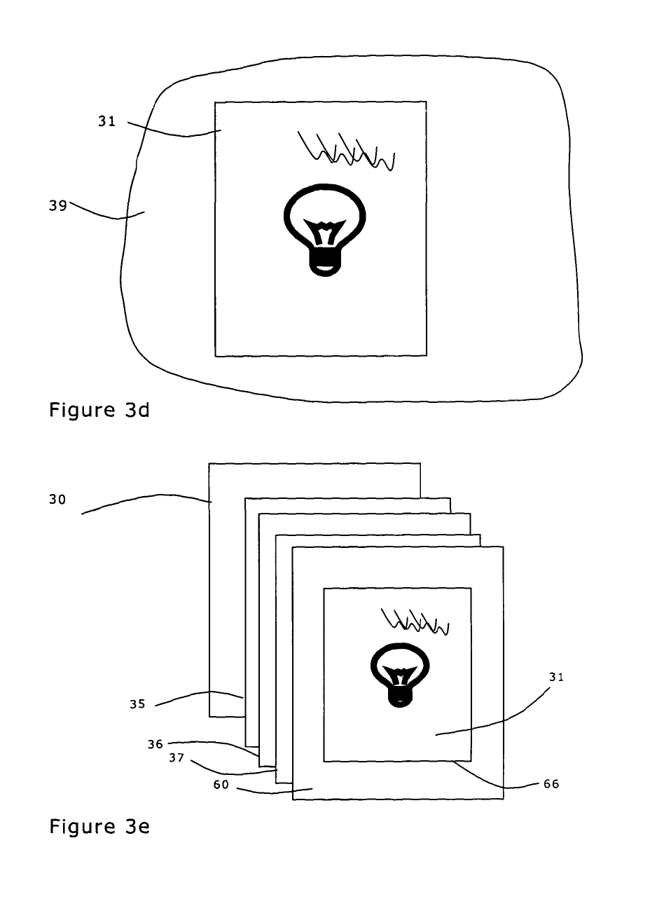

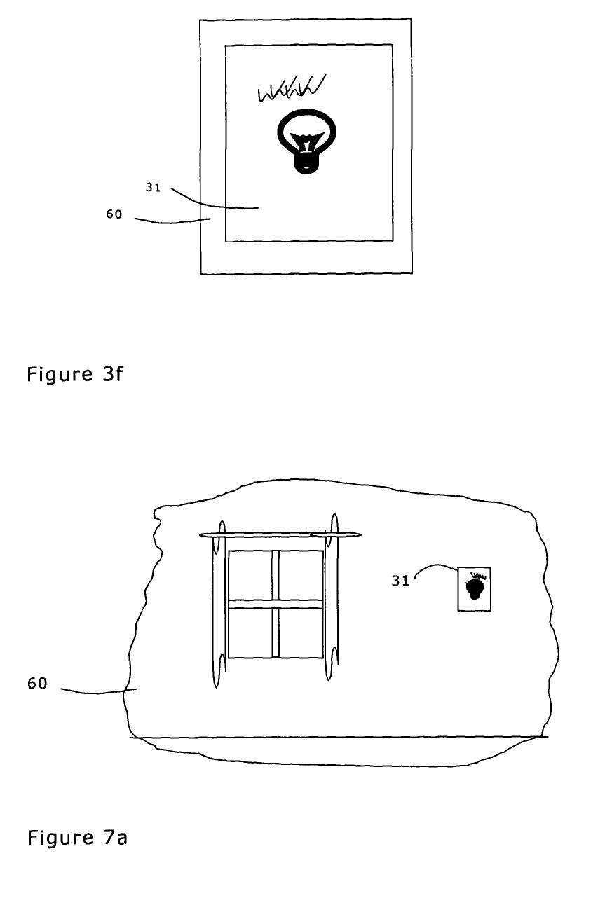

A first embodiment of the invention will now be described with reference to FIGS. 3a, 3b and 3c. In FIG. 3a there is shown a complete hinged or folded card 14, comprising a support card 30 supporting a front face 31 with pictorial representation, in this case comprising a design and graphics, 32. An inside face of the card 33 carries a message. With reference to FIG. 3b, an optional removable adhesive protection sheet 38 is shown in spaced apart fashion from adhesive element sandwich 35, 36, 37, which adhesive sandwich is mounted upon the front face 34 of the support card 30. This adhesive sandwich comprises: a first adhesive layer 35, which is conveniently a low-tack reusable adhesive and attaches to the support card; adhesive support sheet 36 enables a relatively higher tack adhesive 37 to be placed thereon. Sheet 38 is a protective layer for the second adhesive: prior to placement of a selected pictorial representation, the protective layer prevents dirt from getting into contact and sticking to the adhesive. This support card 30 can comprise a consumer item in its own right, without a pictorial representation: As an item of commerce, a purchaser could buy the card arrangement comprising the support card 30, first adhesive 35, adhesive support sheet 36, second adhesive 37 and protective sheet 38 altogether. The purchaser would then attach a picture, photograph or other artwork and attach to the second adhesive having removed the protective sheet. In FIG. 3c, a similar arrangement is shown except that instead of the card being purchased with an adhesive protection sheet 38, the card is purchased with an artwork design, photograph etc 31. It will be appreciated that the card shown on FIG. 3c can be manufactured slightly differently, with the low-tack adhesive and a magnet adhesive lying in substantially the same plane.

Thus, in a first mode of operation, the invention provides a greetings card with a pictorial representation 32, the pictorial representation either being bespoke (not shown) or purchased with the card 14. In a second mode of operation, the card front sheet 31 together with pictorial representation 32 can be removed from the supporting card face 34; the adhesive sandwich comprising the higher tack adhesive 37, adhesive support sheet 36 and re-usable adhesive (preferentially being retained to the adhesive support member by suitable choice of card 30 or treatment to the surface of the front face 34 of card 30). The pictorial representation 31 can then be placed upon another surface 39 by use of the first layer of adhesive 35, as represented by FIG. 3d. Note, however, that the card may not be required to be placed upon another surface at a particular time and an adhesive protection sheet (not shown) may be placed upon the adhesive surface 35. Conveniently, the removable protective sheet 38 from an initial purchase of the bespoke card will have been retained and can be re-used. Alternatively, the card arrangement, at the time of purchase, may be provided with a further protective sheet, in which case such sheet could be retained to the rear of the card by static electricity another adhesive or by other means.

It will be appreciated that the card 14 may comprises a folded card as known as a greetings card, for example a birthday card, Christmas card or a get well card, which is presented within an envelope, to protect the card during despatch, typically by postal mail. It has been found that in order to assist in the separation of the pictorial representation from the support card 30, that the adhesive sandwich is of slightly reduced dimensions relative to the pictorial representation and the support card, whereby, for example, an insert may be placed between the pictorial representation and the support card 30, whereby to assist in separation to enable the pictorial representation to be affixed in its second mode of operation. However, this may not be appropriate for certain types of card.

Referring now to FIG. 3e, there is shown a front part of a card which shows how the card, in a second aspect of the invention, is created. Reference numeral 60 represents the outside face of the card, which is arranged akin to a picture frame, which surrounds the pictorial representation 31 and can additionally comprise a polymeric magnet material and has an aperture 66 for the picture and logo 31. The picture frame can be printed upon, using suitable ink. For example, a wood effect design may be printed upon magnet material. Alternatively the printed sheet of vinyl or other material may be glued directly, but this level of detail is not shown. The picture frame arrangement may be arranged such that a pictorial representation is placed within the frame—backing paper/card sandwich, which is secured directly to the adhesive sandwich as described above. The frame member may comprise, at least in part, a polymeric magnetic element, whereby to enable adhesion with a ferromagnetic surface. FIG. 3f shows how the picture frame 60 concept would look upon completion.

A mount with adhesive tape applied can be either attached to host card or supplied separately/additionally, mount can be card, plastic, magnetic sheet or other suitable materials. The mount will be used when using a photograph or artwork of delicate material or thin paper; using a mount makes it easier to detach from host card and avoids curving.

Card 30 (also referred herein as a host card) can have an aperture(s) perhaps a frame, in this case the host card will have adhesive tape applied to side 3, supplying a host card with apertures allows conventional greeting card finishes to front this may include thermographic printing, embossing, gold foil etc the picture/personal message can be viewed through aperture.

Host card may have more than four sides, with use of an insert or as determined by the manner in which the card is folded, adhesive tape may be attached to more than 1 side. For example, a customer visits a website that enables a selection of a pictorial representation to be applied to the outside of a card, with a particular verse being selected for the outside and the inside (if desired), a personalised message, including name of sender (or not if the card is a St. Valentines card, for example)- to be referred herein after as a digital signature of the sender—together with the name and address of recipient for the envelope. Name and address data may be uploaded, for example from a memory stick (USB stick), in a portable document format. Card forming machinery would then operate, whereby to print the desired messages and the appropriate representations (with or without message across the front) to be applied, to print the address on the envelope, frank the envelope, attach the card components together and insert the finished card within the envelope, close and despatch via courier or postal service. The recipient can decide to detach both picture and personal verse and place on wall, use in scrapbook etc.

It has been determined that the permanent adhesive can be conveniently provided as an aqueous compounded acrylic emulsion. Such adhesives are known for label, paper and film applications, where a permanent bond is required and is generally suitable for application where a permanent bond is required; it is a pressure sensitive adhesive. The releasable adhesive—sometimes referred to as super peel adhesive is also conveniently prepared as an aqueous acrylic adhesive which require low—medium tack and clean removability; it is also a pressure sensitive adhesive. The release material such as satin gloss paper, is conveniently provided as a multi-purpose machine coated paper and is typically used in flexographic, letter press and offset litho printing processes. For convenience in manufacturing, the adhesive layers may be produced separately from the picture card or the supporting card. The adhesive layers would then be manufactured, conveniently applied on separate sides of a satin gloss paper, with release liners applied after the aqueous adhesives have been applied and dried, conveniently by heating. Such preparations are available from Tenza Technologies of Saxmundham, Suffolk, United Kingdom. The inventor has determined that the releasable adhesive can be used, in tests, over hundreds of occasions. Notwithstanding this, if low grade paper is used and residues are left on the adhesive, then life-time of the adhesive will be reduced.

FIGS. 3a-3g above show a removable picture from a card, the size of the card and the removable picture being the same. It will be appreciated that the removable picture may be a different size, conveniently smaller. For example a motto, legend or otherwise may be present on the card, but not on the picture. Equally, the picture may have an acetate sheet or similar arranged to protect the printing ink or artwork.

In the context of the present invention, the term adhesive is intended to cover pressure sensitive adhesive, magnetic card and magnetic polymer sheet, although magnetic properties are only relevant with respect to attachment to ferromagnetic surfaces such as steel filing cabinets, steel refrigerators and the like. Pressure sensitive adhesives (PSAs) form a bond by the application of light pressure to marry the adhesive with the adherend. The bond forms because the adhesive is soft enough to flow (i.e. “wet”) the adherend. The bond has strength because the adhesive is hard enough to resist flow when stress is applied to the bond. Once the adhesive and the adherend are in close proximity, molecular interactions, such as Van der Waals” forces, become involved in the bond, contributing significantly to its ultimate strength. Whilst, pressure sensitive adhesives can be designed for either permanent or removable applications, it is intended that the primary type for the present invention will be for removable applications. Removable adhesives are designed to form a temporary bond, and ideally can be removed after months or years without leaving residue on the adherend. The adhesives are typically applied so that the adhesive thickness is in the region of 0.2-0.5 mm. The skilled man will know to vary the thickness, dependent upon likely usage and type of backing to which the adhesive will be applied, amongst other factors. It will be appreciated that in the use of pressure sensitive adhesives upon a paper/card surface, there will be an interaction with the fibres of the paper/card, which assists

Magnetic rubber sheeting is flexible and versatile; it is considered to have properties suitable for many temporary attachment applications. It can be cut with scissors and is available with adhesive backing or brightly coloured vinyl facing. It is available in rolls and sheets and can be of the order of as low as 0.3 mm. A flexible magnetic sheet material which can contain, for example, a dispersion of magnetic particles within a polymeric matrix. The polymeric matrix can be, for example, a rubber material and the magnetic particles may be ferrite particles, for example barium or strontium ferrite. The magnetic sheet may be anisotropic or isotropic. In one embodiment, the magnetic sheet is an anisotropic material. When the sheet is anisotropic, the magnetic polarity extends across the sheet from one surface to the other with the consequence that the sheets can be stacked. Due to their elastic nature polymer magnetic sheets typically do not have a tendency to curl at edges of a sheet. It will be appreciated that the magnetic polymer must be free from grease, etc when adhesives are applied thereto.

It will be appreciated, that the adhesive employed on the rear of the picture may be of a single type, such as comprising only a pressure sensitive adhesive, or only a magnetic adhesive. Indeed, in such a case, where the adhesive is of a pressure sensitive composition, the support element card 35 need not also be provided with a layer of pressure sensitive adhesive; this alternative would be less costly to manufacture than one with a mixture of magnetic adhesive and pressure sensitive adhesive. In a still further embodiment, instead of a magnet, a polymer adhesive may be employed which is of the type that can be washed with cold water to “re-fresh” its adhesive properties, whereby the photograph or artwork may be moved form time-to-time, without detriment. However, it is believed that a pressure sensitive adhesive should be sufficient for most surfaces. It is also possible to have both types of adhesive on one card.

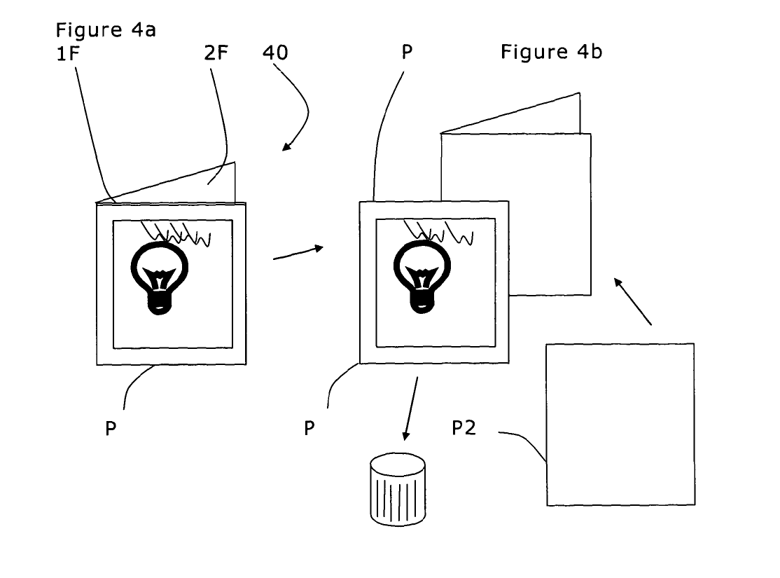

Referring now to FIG. 4a, there is shown, a first embodiment of the invention. A card 40 comprising a substantially rectangular piece of card, which has a fold line to provide first and second leaves attached at a fold line. An inside surface of the second leaf, 2F, has a message written, by pen, printer or otherwise, the first leaf has a removable adhesive attached to it whereby a picture, drawing, message or other form of generally planar decoration P can be removably affixed thereto. A message may also be placed here. After the decoration is out of date/faded/ is required to be changed, whether on a whim or with purpose, then the picture can be removed and the picture replaced with a second decoration P2.

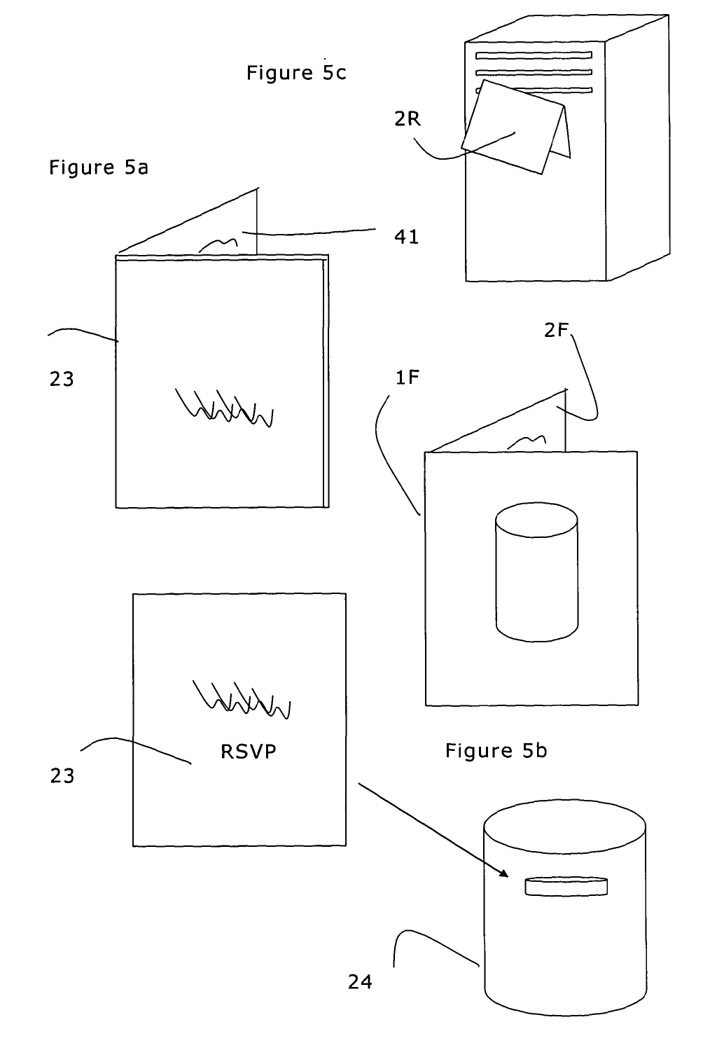

An invitation card is shown in FIG. 5a. The card 41 comprises a folded card as shown with reference to FIG. 4a. However, in this case the front decoration, attached by a releasable adhesive glue adhered to the outside face of the first leaf 1F of the card is a reply card to the invitation. The reply card 23 is detached, per FIG. 5b, signed as appropriate and placed in a post box 24. In this instance the adhesive of the outside front face 1F is then used to enable the card to be stuck to an item of furniture, such a fridge, 78, as shown in FIG. 5c, to act as a reminder of the event. In another embodiment, the second face also has a removable card, which can be provided with an adhesive whereby it may releasably be attached to a fridge etc. after separation form a support card, whereby to serve as a reminder, the card only having served to comprise a support material, the reminder card having a releasable adhesive applied to the rear of the reminder card face carrying the reminder note, the reminder card may be have an adhesive carrier substrate as disclosed below. It may be useful to have the adhesive

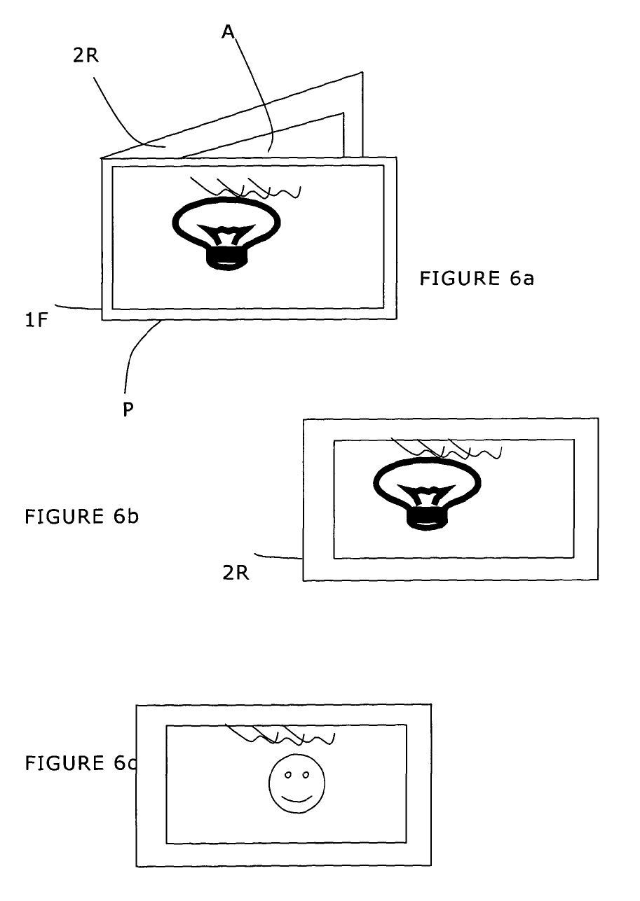

FIG. 6a shows a still further embodiment, wherein the rear leaf 2R of the card has an aperture, A, whereby the second leaf of the card can be folded back upon itself whereby to be attached, along a peripheral edge of the front face of the first leaf of the card 1F, which peripheral area is not covered by a picture P, as shown in FIG. 6b. The message written upon the inside of the frame, when the leaf of the inside face 2F was as originally folded, can comprise a secret message. The message, may relate to a grandson: in time the message stays the same, but the child grows up: The picture may be changed to reflect the correct stature of the child or may be changed to show the child involved in a topical interest event. FIG. 6c shows the card with a different picture.

The rear face of the second leaf, 2R, becomes the picture frame; it can be printed upon, using suitable ink. For example, a wood effect design may be printed upon magnet material. In the alternative, the first leaf has an aperture and the second leaf carries the picture by way of a releasable adhesive. Alternatively the printed sheet of vinyl or other material may be glued directly, but this level of detail is not shown. The picture frame arrangement may be arranged such that a pictorial representation is placed within the frame—backing paper/card sandwich, which is secured directly to the adhesive sandwich as described above.

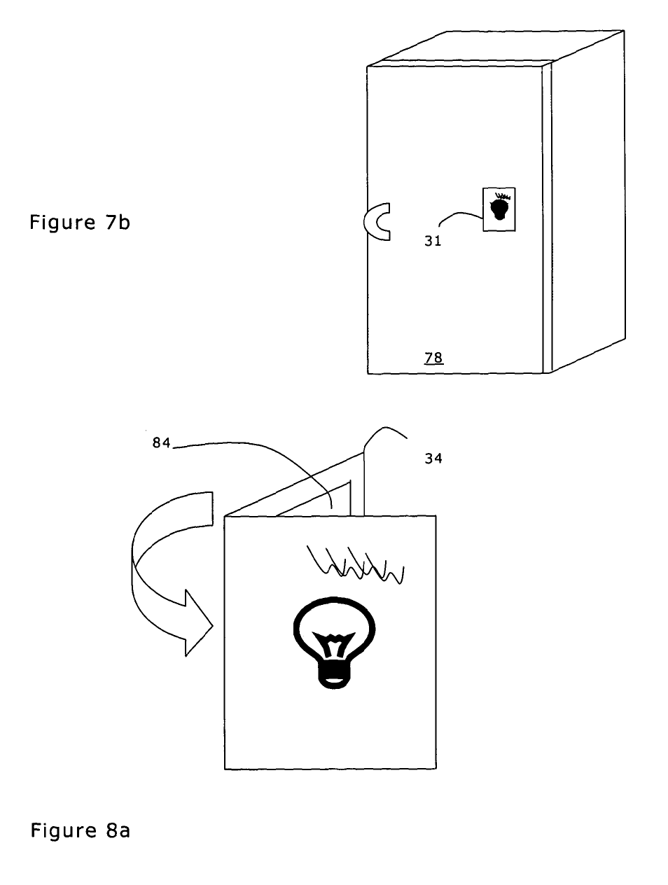

Once use of the card has ended—e.g. in the case of a birthday card it is more than four weeks since the event—the front card 31 with adhesive can be removed from the support card 30; the picture/photograph/print/ or other artwork (to be referred to collectively, hereinafter, as the “picture”) may then be displayed separately from the inside message and support of the card member 30. With reference to FIG. 7a, the picture is shown mounted on a card 31 which is attached to a wall 46 of a dwelling or office, the card being attached to the wall by a pressure sensitive adhesive. Obviously, the plastic film protective sheets would need to be removed prior to placement of the pressure sensitive adhesive against a suitable surface—which would not include dusty surfaces, as would be understood. FIG. 7b shows the card 31 attached to a fridge 78, in a fashion employed by devices known as fridge magnets, where a novelty including a magnet is attached to a refrigerator, the outer skin of which generally comprises a ferromagnetic material. If two adhesive types are present, then the pressure sensitive adhesive protector 44 need not be removed.

It will be appreciated that many variations of the invention are possible; the degree of personalization can be enhanced and extended by virtue of the increased longevity of the card. The card of the card support member may be made so that it id particularly durable; instead of, or in addition to, the pictorial representation being removable, the inside greeting may be removable—and replaceable. Such a trend could be as sited by marketing and, indeed a website community advocating the use of such a re-usable card. This could have significant ecological benefits given the number of cards that are sent in countries such as the United Kingdom. Accordingly, it is intended that the claims are interpreted such that the pictorial representation could be removed or the message inside the card is capable of being removed and replaced by another message. In one sense this is similar to the corporate envelope which has multiple address panels. Equally, a person may also wish to personalise the front of the card as well as the message inside.

The pictorial representation may conveniently be printed using standard printing equipment—including simple home-office black & white or colour printers—without the presence of a thick backing card and thus the personalisation details can be greater than many present cards on the market. For example, the card may comprise a plastics sheet; the pictorial representation, as mentioned above, may comprise one of many kinds of artwork; it may be a three-dimensional collage, a water-colour, a photograph (the card may have one or more small apertures to enable the mounting of a passport-photo size pictures etc. Professional caricaturists, for example can find a ready format whereby their work is enjoyed in a traditional fashion, but that the composition can be more easily be enjoyed for longer. It will be appreciated that the manner of selling the cards could change: customers could place orders on-line—variations can be easily attained; customers could upload digital photographs—and actual photos of friends and dogs etc can be included, rather than selecting a card with a dog that looks similar to owners, for example, a parent may include photo of child for Grandparent. If the placement of an order is made on-line, then a digital copy of a signature could be applied; equally the greeting may comprise a scanned-in document portable document file (PDF). It can readily be envisaged that communities of artists may cooperate to enable the sharing of pictorial representations from such a community, a file storage device could enable any one or more pictorial representations to be selected for a customer, either singly or for multiple purchases. The adhesive layers, referenced 35, 36 & 37 may be sold on their own to facilitate hobby-type folk to create their own cards, although it is anticipated that they may well use a professionally produced support card 30. In another aspect of the invention, the adhesive 35 may be applied to a pictorial representation, but it is believed that many pictorial representation, particularly photographic papers may be affected by such adhesive.

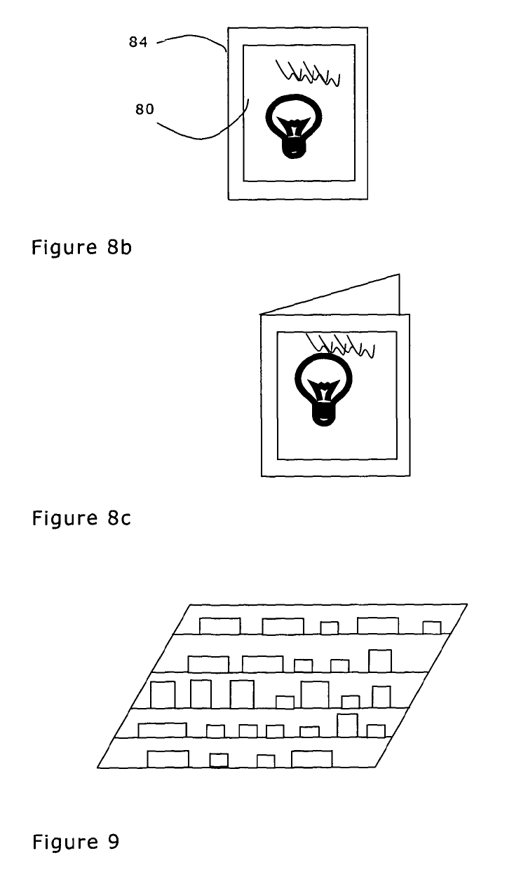

FIGS. 8a and 8b show how an aperture 80 in a card or layer of card associated with the rear of the card member 34 can provide a frame 82 to be used over the front face of the card. Further, the benefits of personalization are likely to be so easily achieved to the extent that instead of being an economy option, a premium option could be provided by the invention. Equally a selection of known prints could be utilized, as is already known in on-line scenarios. Traditional premium features such as including a fly leaf, having a store voucher or coupon or lottery ticket will also be possible. Additionally, the frame 84 may be placed at the front so that the card may stand in an upright fashion, the pictorial representation being viewed through the frame, per FIG. 8c.

It will be appreciated that whilst the cards shown have all had a generally rectangular shape, non rectangular cards can be made in accordance with the invention; they need not be regular shapes. Further, the card may comprise a picture post-card style greeting card, with the address and greeting section comprising the releasable backing paper for an adhesive on the reverse of the picture. Equally, the card may comprise more than one hinged section; the pictorial representation may be detached from the support card 30, which may have one or more hinged sections.

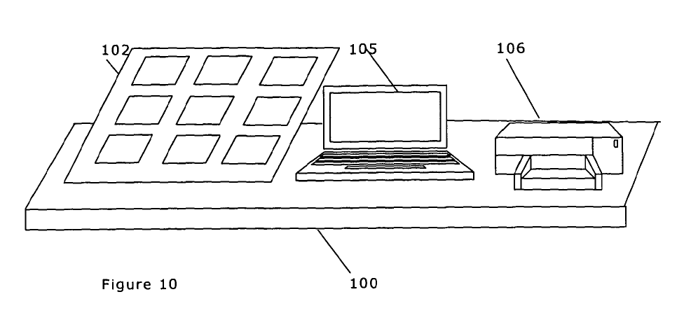

In accordance with a further aspect of the invention, there is provided a system for producing a greetings card. It is known to have several display shelving arrangements in shops which sell cards, each having 5-15 or so shelves which are slantingly arranged against a wall, against the back of similar or different units. An example of this is shown in FIG. 9. Customers are able to view and select such cards; a pictorial representation is obtained and attached to a blank comprising a card with a greeting or space for a greeting written by hand or printed from, for example, a pdf representation and adhesive arrangement, whereby a card is selected with a suitable greeting, which is paired with a particular pictorial representation; the protective film on the outermost adhesive layer of the card is removed and the pictorial representation is attached. Cards tend to be priced in accordance with a price letter, whereby the price of the card does not become known to the recipient; once selected a card is taken to a cashier and payment can be made. It is also known for cards to be selected by viewing on the world-wide-web (the “web”), a card site (“website”) where cards can be selected from a range of stored images, mottoes etc and which cards can have a selected message placed within and signed, for example with a digital copy of a signature of the person sending the card, as discussed above.

The manner of purchase of a card via a website may be replicated at a card shop: As shown in FIG. 10 there is provided a point of sale arrangement 100 comprising a visual display unit or monitor 105, input keys and a printer 106. A user can select the image from a fixed selection 102 to be placed on the front cover, the text to be selected, including a signature, whether typed in or from a digital signature entered in via wireless from a personal data assistant such as a Blackberry®, or signature may be written upon the card once completed. With regard to a picture to be printed, the same may be selected from a digital image library, or uploaded form an electronic communication, via e-mail, a usb stick or other memory device. Equally the selected image may be a specific artwork, to which a suitable adhesive is placed on the rear side thereof and attached to the polymeric magnet/releasable adhesive, dependent upon the way the card is arranged. It will be appreciated that the system will need a usb port, internet connection or similar to enable at least some of the further functionalities to be provided. It may be appropriate for a pre-payment system be utilised, since once one has printed a new card tailor made to one's own specification, re-sale to another is highly unlikely. In the alternative, the card blanks could be supplied in sets of ten, for example, whereby a purchaser can provide custom cards, which due to the professional card support appear to be professionally made, yet the personalised pictorial representations are personal and particular to the sender of the card and/or the recipient. It will be appreciated that the card may be a post-card type of card and does not necessarily need to be a folded card.

The present invention could also be employed as a memento. For example, when one visits a particular event, there may be a photographer available who would be available to take a photograph of a visitor, with a background of the building, event, show meeting with personalities etc. After taking the photograph, a card could be created whereby a memento of the event is provided as a card. The card could be taken home, sent to a friend or relative etc. After use as a greetings card, one of the message or of the pictorial representation of the memento may be placed upon a wall, a refrigerator, metal filing cabinet etc.

In a still further embodiment of the invention, a pictorial representation may be treated such that it is capable of retaining a releasable adhesive, which pictorial representation is attached to the support card with greeting.

1. A greetings card comprising a support member having an inside face suitable for adding a greeting, an adhesive member, the adhesive member comprising a first layer of adhesive, a carrier layer and a second layer of adhesive wherein the card and the adhesive member are adapted to engage with a picture to provide a card having a pictorial representation and; wherein the pictorial representation is adhesively secured to the carrier member by the second layer of adhesive and the carrier member is adhesively secured to the support member by the first layer of adhesive.

2. A greetings card according to claim 1, wherein the first adhesive is a pressure sensitive adhesive; once released from the support card, the pictorial representation can be replaced by another and the card can be reused.

3. A greetings card according to claim 1, wherein the first adhesive is a pressure sensitive adhesive; once released from the support card, the pictorial representation can be adhesively secured to an object.

4. A greetings card according to claim 1, wherein the second adhesive is a pressure sensitive adhesive; once released from the support card, the support card can be adhesively secured to an object.

5. A greetings card according to claim 1, wherein the first and second adhesives comprise pressure sensitive adhesive; once separated, one of the support card and the pictorial representation can be adhesively secured to an object, utilising the adhesive member.

6. A greetings card according to claim 1, wherein the pictorial representation comprises one of a photograph, a painting, a three-dimensional collage or other form of two or three-dimensional artwork.

7. A greetings card according to claim 1, wherein the card comprises a generally rectangular shape.

8. A greetings card according to claim 5, wherein a first layer of adhesive is a releasable, low tack adhesive and the second layer of adhesive is a stronger adhesive.

9. A greetings card according to claim 6, wherein the low tack adhesive is an aqueous acrylic adhesive.

10. A greetings card according to claim 1, wherein the support member is manufactured from cardboard or a plastics film.

11. A greetings card component operable in accordance with claim 1, comprising a support member having an inside face suitable for adding a greeting, an adhesive member, the adhesive member comprising a first layer of adhesive, a carrier layer and a second layer of adhesive wherein the card and the adhesive member are adapted to engage with a pictorial representation; wherein there is provided a film of material operable to protect the permanent adhesive member prior to presentation of a pictorial representation to the adhesive.

12. A greetings card component according to claim 10, wherein a first layer of adhesive is a releasable, low tack adhesive and the second layer of adhesive is a stronger adhesive.

13. An adhesive member for a greetings card operable in accordance with claim 1, comprising a first layer of reusable adhesive, a carrier layer and a second layer of permanent adhesive.

14. A greetings card according to claim 13 wherein there is further provided an address label in a removable configuration with a resealable adhesive.

15. A greetings card according to claim 1 wherein the message greeting is removable using the resealable adhesive.

16. A greetings card according to claim 1, wherein the resealable adhesive member comprises part of the card.

17. A greetings card according to claim 1 wherein one of the adhesives also includes ferromagnetic adhesive material, whereby to assist in attachment to a ferromagnetic body.

18. A method of making a greetings card in accordance with claim 1, said method comprising the steps of:
selecting an image;
selecting a support card; and,
attaching the image to the support card using an adhesive member comprising a support sheet with first and second adhesive layers on first and second sides of the support sheet.
